(19) United States
(12) Patent Application Publication
(10) Pub. No.: US 2004/0103144 A1
(43) Pub. Date: May 27, 2004

(54) Systems and methods for communicating with devices as Web Services

(76) Inventors: Hussein Sallam, Clarksville, MD (US); David Lee Walsh, Jessup, MD (US)

Correspondence Address: John Kasha, Shaw Pittman LLP, 1650 Tysons Boulevard, McLean, VA, 22102, US

(21) Appl. No.: 10/706,974

(22) Filed: Nov. 14, 2003

Related U.S. Application Data
(60) Provisional application No. 60/428,903, filed on Nov. 26, 2002.
(60) Provisional application No. 60/428,904, filed on Nov. 26, 2002.
(60) Provisional application No. 60/428,905, filed on Nov. 26, 2002.

(51) Int. Cl. G06F 15/16

(52) U.S. Cl. 709/203; 709/236

(57) ABSTRACT

Embodiments of the present invention relate to systems and methods for communicating with smart telemetry devices as Web Services. Communication between a software application and a smart telemetry is facilitated by a server. The server accepts a request from the application, forwards the request to the smart telemetry devices, receives information from the smart telemetry device, and returns the information to the software application. The server communicates with the software application via a Web Service technology. The server communicates with the smart telemetry device either via a Web Service technology or via a protocol native to the smart telemetry device. In an exemplary embodiment of the invention, a gas or liquid tank is monitored by a system that includes a software application, a smart telemetry device, a device providing user alerts, and a server.

### CROSS-REFERENCE TO RELATED APPLICATION

This application claims the benefit of U.S. Provisional Patent Applications Serial No. 60/428,903 filed Nov. 26, 2002, Serial No. 60/428,904 filed Nov. 26, 2002, and Serial No. 60/428,905 filed Nov. 26, 2002 which are herein incorporated by reference in their entirety.

### BACKGROUND OF THE INVENTION

1. Field of the Invention

Embodiments of the present invention relate to communicating with devices as Web Services. More particularly, embodiments of the present invention relate to systems and methods for communicating with telemetry devices so that those devices can be accessed and controlled as Web Services.

2. Background Information

I. Telemetry Devices

Telemetry is defined by The American Heritage® Dictionary as “the science and technology of automatic measurement and transmission of data by wire, radio, or other means from remote sources . . . to receiving stations for recording and analysis.” Smart telemetry devices are devices that automatically measure and transmit data via a network. They typically consist of a controller device and a monitor device. The monitor device is typically a sensor and conveys a measurement to the controller device. The controller device receives or reads the measurement of the monitor device, and it transmits that data via a network protocol.

In the past, smart telemetry devices have used custom data formats and transmission protocols to transmit data. The use of such formats and protocols made it very difficult for the telemetry data to be integrated into software applications. Each software application required modification to accept each new type of telemetry data. This resulted in costly custom software integration and often discouraged businesses from integrating telemetry data with their software applications.

II. Software Integration of Telemetry Devices

A number of different methods have been used to integrate smart telemetry devices into enterprise systems. These methods include custom integration, API-based middleware, and component-based middleware.

A. Custom Integration

The custom integration solution has been the most common means of integrating telemetry devices. FIG. 1 is a diagram showing a known tightly-coupled custom integration method for integrating telemetry devices with an application. This solution involves writing custom software that interfaces directly with device 10 and directly with application 11. This custom software, 12, usually contains two main components: device driver 13 and application interface 14.

The developer that writes device driver 13 often has to be familiar with the low level inner workings of the operating system. This is a technically difficult task that only a small number of software engineers are capable of doing. In addition, the developer has to read through reference manuals to learn how a device 10 functions to interface with it. This type of development effort is often much more difficult and costly than typical application development.

In addition to providing customized solutions for specific operating systems, often the solutions must be designed for specific versions of those operating systems. For example, device drivers written for WINDOW 98™ are not compatible with WINDOWS 2000™ or WINDOWS XP™.

Application interface 14 requires a developer to either integrate software directly into the application or to learn an application specific programming interface (API). Direct integration is typically only possible if the developer has access to the source code for the application. For larger and third party applications, the most likely solution is to use an API. Learning an API, however, can be a time consuming and expensive process.

B. API-Based Middleware

A number of API-based Middleware products were introduced over the years to try and solve the device integration problem. FIG. 2 is a diagram showing a typical API-based middleware method for integrating telemetry devices with an application. This method involves a gateway or portal system that is running middleware software 20. Software device connectors 21 are then the bridge between middleware software 20 and each device 22. A software device connector 21 is integrated in one of two ways. First, it is integrated into the device itself so that the device may communicate with the middleware. This limits the middleware to newly developed devices only. Second, it is integrated external to the device, either as a plug-in for the middleware or as a separate appliance. In this case, the middleware vendor has to supply a Software Development Kit (SDK) for each platform and language being used by the device developers.

In regard to application 23, this method allows application developers to use a single API interface to communicate with a any class of devices for which a software device connector 21 has been written. This means that the application developer can develop independently from the device manufacturer. Also, the API interface does not have to be modified every time there is a new device. This was a major advance over the custom integration solution.

However, a software application integration connector, 24, is still required to bridge the gap between the middleware and the application APIs. Furthermore, application integration connector 24 is still specific to the middleware and the middleware manufacturer has to supply language and platform specific libraries to the developers in order to create the connector. Library versioning problems make this a very difficult software system to maintain in a reliable fashion.

C. Component-Based Middleware

The component-based middleware method involves the use of component technologies such as COM™/DCOM™, CORBA™ and JAVA BEANS™. FIG. 3 is a diagram showing a typical component-based middleware method for integrating telemetry devices with an application. The basic idea is to create a standard software interface for a class of devices. Then each device 30 has its own “component” middleware 31 that implements interface for that specific device 30. A software connector 32 is still needed to bridge the gap between application 33 and component middleware 31.

One example of component-based middleware is OLE for Process Control (OPC). OPC defines a set of component interfaces used in the process control industry based on the Microsoft COM™ component technology. Each device manufacturer then creates an OPC component for each model of device. Application developers and integrators then develop their software to use a common interface that is independent of device vendor.

Component-based middleware is a significant improvement over API-based middleware. It allows application and integration developers to work independently from middleware and device vendors. By having a component interface standard such as OPC, application developers can develop support for devices into their application without having to worry about support from a middleware vendor. In addition, component technologies such as CORBA™ and COM™ are somewhat language independent. They also address interface versioning issues so that component interfaces can evolve in a controlled manner.

However, the downside is that components are typically platform and architecture dependent. For example, a COM™ component designed for a WINDOWS NT™ system cannot be used with a Unix system. Also, the component-based middleware solution requires device manufacturers to make investments in developing software components. Device manufacturers are typically hardware-based companies that do not have in-house software expertise. Therefore, the notion of supporting multiple component technologies for multiple platforms is a daunting task for device manufacturers. And often it is not undertaken with much success.

In view of the foregoing, it can be appreciated that a substantial need exists for systems and methods that can advantageously provide for the integration of smart telemetry devices with applications of an enterprise system.

### BRIEF SUMMARY OF THE INVENTION

Embodiments of the present invention relate to systems and methods for communicating with smart telemetry devices within an enterprise system. In a preferred embodiment the communication between the smart devices and the enterprise system is via Web Services.

One basic embodiment of such a system includes a software application, a smart telemetry device, and a server. The smart telemetry device includes a controller device and a monitor device. The server accepts a request from the software application for discovering, configuring, or controlling the smart telemetry device via a Web Service technology. This technology includes but is not limited to XML, SOAP, WSDL, UDDI, HTTP, and SMTP. The server then forwards the request to the smart telemetry device via a protocol native to the telemetry device. Information sent from the smart telemetry device in response to the request is passed to the server via the protocol native to the telemetry device. Finally, the server returns the information to the application via the same Web Service technology of the original request.

In another embodiment, the communication between the server and the smart telemetry device is also via a Web Service technology. The server forwards the request from the application to the smart telemetry device via a Web Service technology. Likewise, the information sent from the smart telemetry device in response to the request is passed to the server via the same Web Service technology.

In either embodiment, the server functions can be organized into three separate categories. These are Web Services accessible to the software application that provide communication and management interfaces for the smart telemetry device, an infrastructure allowing for the smart telemetry device to exchange services with the server, and core Web Services that provide functionality to both the software application and the smart telemetry device.

The Web Services accessible to the software application that provide communication and management interfaces for the smart telemetry device include but are not limited to configuration management, directory services, messaging services, security services, and device specific services. The infrastructure allowing for the smart telemetry device to exchange services with the server includes but is not limited to a device message service, a device message translator, a device extension service, and a device switchboard. The core Web Services that provide functionality to both the software application and the smart telemetry device include but are not limited to configuration management, universal messaging, dial-tone access management, security services, and device class interfaces.

An embodiment of a method used by a server to facilitate the communication between a software application and a smart telemetry device includes four steps. First, the server accepts a request from the software application comprising discovering, configuring, and controlling the smart telemetry device via a Web Service technology. Second, the server forwards the request to the smart telemetry device via a protocol native to the smart telemetry device. Third, the server receives information from the smart telemetry device in response to the request via the protocol native to the smart telemetry device. Fourth, the server returns the information to the software application via the Web Service technology.

In another embodiment, the server forwards the request to the smart telemetry device via a Web Service technology. The server then receives the information from the smart telemetry device in response to the request via the same Web Service technology.

These methods involve requests initiated by the application. A request may also be initiated by the smart telemetry device. In one embodiment, the server first accepts a request from the smart telemetry device to send information to the application via a protocol native to the smart telemetry device. It then forwards the information to the application via a Web Service technology. In another embodiment, the server first accepts a request from the smart telemetry device to send information to the application via a first Web Service technology. It then forwards the information to the application via a second Web Service technology.

In another embodiment, a method by which a server, which acts as proxy between a smart telemetry device and an application, communicates with a smart telemetry device is provided. This method begins by receiving a message from the smart telemetry device in a Web Service technology. This technology includes XML. The identity of the smart telemetry device is then determined from the address or device class information contained in the message. The server then selects a device description document, which specifies how the smart telemetry device communicates with the server, from the identity of the smart telemetry device. Finally, the server translates the body of the message using the device description document.

In order for a server to receive a message from a smart device in a Web Service technology, the smart device must be capable of generating such a message. Another embodiment of the present invention is a system for a smart telemetry device to communicate with an application via an XML format. This system includes a communications link that provides the transport for exchanging messages between the smart telemetry device and the application. The system also includes an input message queue that stores incoming messages and an output message queue that stores outgoing messages. An incoming message is directed to an XML message processor that parses the incoming message and forwards the payload of the incoming message to a firmware function. An outgoing message is generated by an XML message generator that converts a firmware-generated message to XML. Finally, the system includes device specific functions that are firmware functions that make up the smart telemetry device's functionality.

A specific embodiment of the present invention is a liquid and gas tank telemetry system. This system includes a tank containing a liquid, a gas, or both. The system has one or more sensors attached to the tank to provide information about the tank. This information includes tank pressure, line pressure, tank level, tank temperature, tank leakage detection, and flow rate in and out of the tank. The system includes a telemetry device that automatically receives or reads data from the one or more sensors. The system has a telemetry database that stores telemetry data. The system also includes at least on software application. Such software applications include but are not limited to inventory, scheduling and routing, billing or invoice, and enterprise resource planning systems. The system also has a device for communicating telemetry alerts to a user. The device for communicating telemetry alerts to a user include but at not limited to a computer, PDA, cellular phone, telephone, and pager. Finally, the system is controlled by a telemetry server that communicates with the telemetry device, retrieves and stores data in the telemetry database, provides an interface to the software application, and forwards telemetry alerts to a means for communication telemetry alerts to a user.

### BRIEF DESCRIPTION OF THE DRAWINGS

FIG. 1 is a diagram showing a known tightly-coupled custom integration method for integrating telemetry devices with an application.

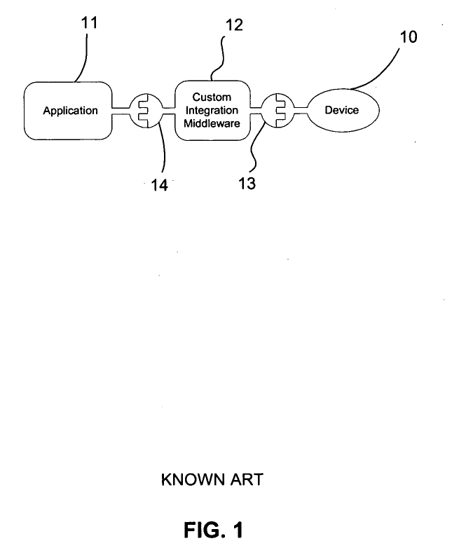

FIG. 2 is a diagram showing a typical API-based middleware method for integrating telemetry devices with an application.

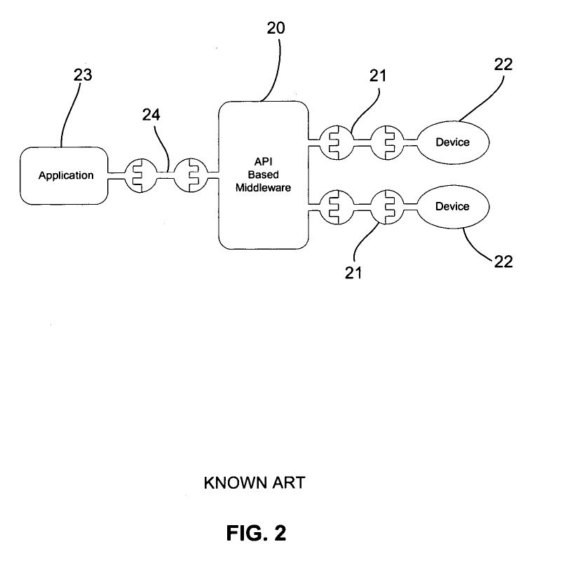

FIG. 3 is a diagram showing a typical component-based middleware method for integrating telemetry devices with an application.

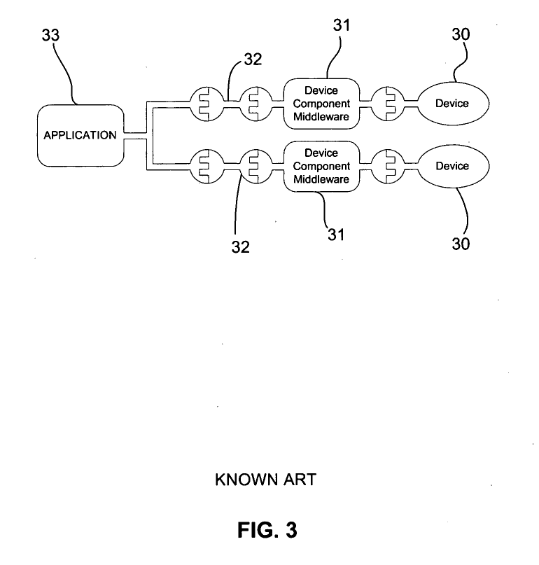

FIG. 4 is a schematic diagram showing an exemplary system for communicating with smart telemetry devices as Web Services in accordance with an embodiment of the present invention.

FIG. 5 is a flowchart showing an exemplary method used by a server to proxy communications between a software application and a smart telemetry device where the request is initiated by the application and the communication to and from the smart telemetry device is via a protocol native to the smart telemetry device in accordance with an embodiment of the present invention.

FIG. 6 is a flowchart showing an exemplary method used by a server to proxy communications between a software application and a smart telemetry device where the request is initiated by the application and the communication to and from the smart telemetry device is via a Web Service technology in accordance with an embodiment of the present invention.

FIG. 7 is a flowchart showing an exemplary method used by a server to proxy communications between a software application and a smart telemetry device where the request is initiated by the smart telemetry device and the communication to and from the smart telemetry device is via a protocol native to the smart telemetry device in accordance with an embodiment of the present invention.

FIG. 8 is a flowchart showing an exemplary method used by a server to proxy communications between a software application and a smart telemetry device where the request is initiated by the smart telemetry device and the communication to and from the smart telemetry device is via a Web Service technology in accordance with an embodiment of the present invention.

FIG. 9 is a schematic diagram showing the three separate categories of server functions provided by a server that proxies communication between a smart telemetry device and an application in accordance with an embodiment of the present invention.

FIG. 10 is a schematic diagram showing the server functions that allow software applications to manage and access telemetry data in accordance with an embodiment of the present invention.

FIG. 11 is a schematic diagram showing the server functions that make up the infrastructure allowing for the smart telemetry device to exchange services with the server in accordance with an embodiment of the present invention.

FIG. 12 is a schematic diagram showing the server functions that make up core Web Services that provide functionality to both the software application and the smart telemetry device in accordance with an embodiment of the present invention.

FIG. 13 is a flowchart showing an exemplary method used by a server to translate messages from a smart telemetry device in accordance with an embodiment of the present invention.

FIG. 14 is a schematic diagram showing an exemplary system allowing a smart telemetry device to communicate with a software application via an XML format in accordance with an embodiment of the present invention.

FIG. 15 is a schematic diagram showing an exemplary liquid and gas tank telemetry system in accordance with an embodiment of the present invention.

### DETAILED DESCRIPTION OF THE INVENTION

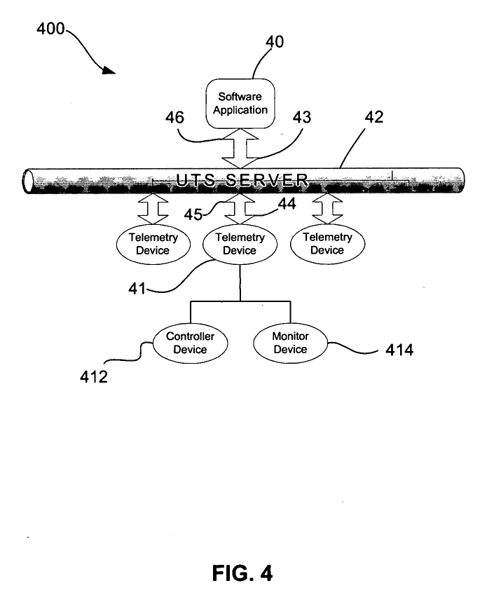

FIG. 4 is a schematic diagram showing an exemplary system for communicating with smart telemetry devices as Web Services in accordance with an embodiment of the present invention. System 400 includes software application 40, at least one smart telemetry device, 41, and Universal Telemetry System (UTS) server 42. Server 42 accepts a request from software application 40 for discovering, configuring, or controlling smart telemetry device 41 via a Web Service technology at 43. Server 42 forwards the request to smart telemetry device 41 via a protocol native to smart telemetry device 41 at 44. Server 42 receives information from smart telemetry device 41 in response to the request via a protocol native to smart telemetry device 41 at 45. Server 42 returns the information to the software application via the Web Service technology at 46. The Web Service technology used includes but is not limited to XML, SOAP, WSDL, UDDI, HTTP, and SMTP. Each smart telemetry device 41 includes controller device 412 to communicate over a network and monitor device 414 to take measurements.

In another embodiment, smart telemetry device 41 communicates with server 42 via a Web Service technology. In this case, server 42 forwards the request to smart telemetry device 41 via a Web Service technology at 44. Server 42 receives information from smart telemetry device 41 in response to the request via a Web Service technology at 45. The Web Service technology used to communicate between smart telemetry device 41 and server 42 includes but is not limited to XML, SOAP, WSDL, UDDI, HTTP, and SMTP.

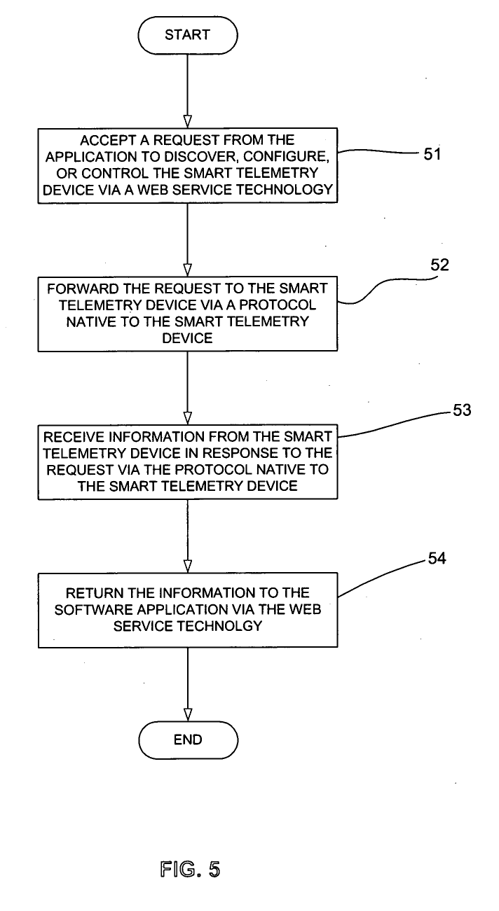

FIG. 5 is a flowchart showing an exemplary method used by a server to proxy communications between a software application and a smart telemetry device where the request is initiated by the application and the communication to and from the smart telemetry device is via a protocol native to the smart telemetry device in accordance with an embodiment of the present invention.

In step 51, the server accepts a request from the software application to discover, configure, or control the smart telemetry device via a Web Service technology.

In step 52, the server then forwards the request to the smart telemetry device via a protocol native to the smart telemetry device. In step 53, information is received by the server from the smart telemetry device via the protocol native to the smart telemetry device.

Finally, in step 54, the server returns the information to the software application via the Web Service technology.

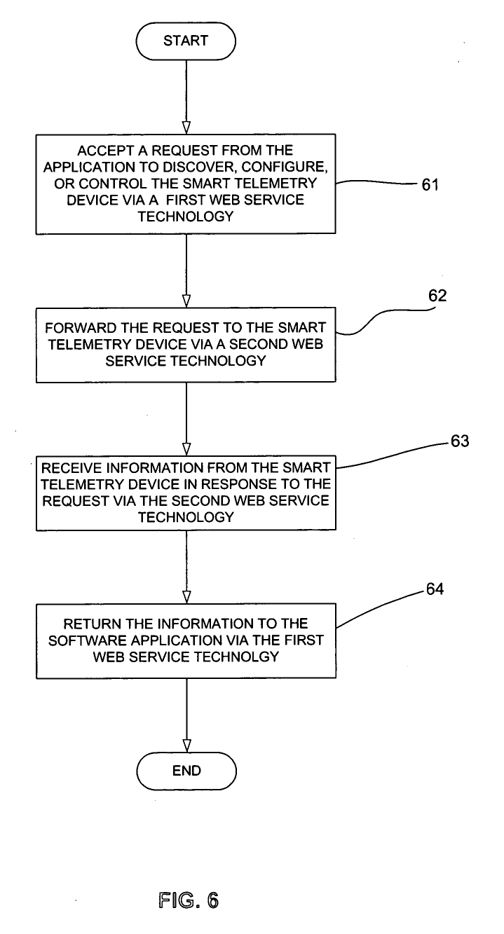

FIG. 6 is a flowchart showing an exemplary method used by a server to proxy communications between a software application and a smart telemetry device where the request is initiated by the application and the communication to and from the smart telemetry device is via a Web Service technology in accordance with an embodiment of the present invention.

In step 61, the server accepts a request from the software application to discover, configure, or control the smart telemetry device via a first Web Service technology.

In step 62, the server then forwards the request to the smart telemetry device via a second Web Service technology.

In step 63, information is received by the server from the smart telemetry device via the second.Web Service technology.

Finally, in step 64, the server returns the information to the software application via the first Web Service technology at 64.

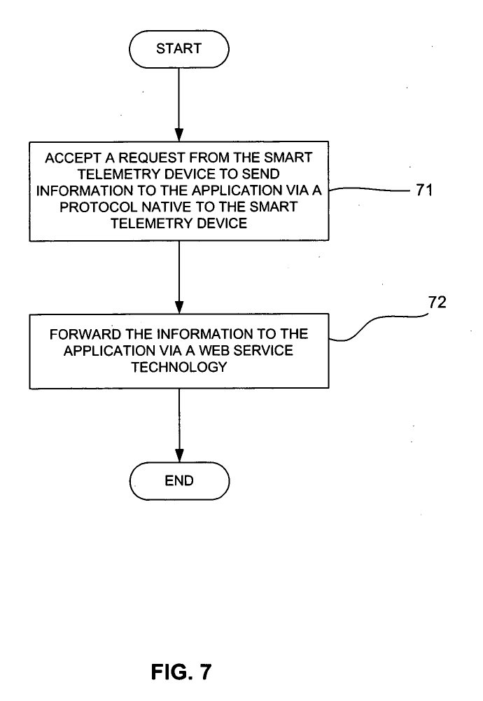

FIG. 7 is a flowchart showing an exemplary method used by a server to proxy communications between a software application and a smart telemetry device where the request is initiated by the smart telemetry device and the communication to and from the smart telemetry device is via a protocol native to the smart telemetry device in accordance with an embodiment of the present invention.

In step 71, the server accepts a request from the smart telemetry device to send information to the application via a protocol native to the smart telemetry device.

In step 72, the server then forwards the request to the application via a Web Service technology.

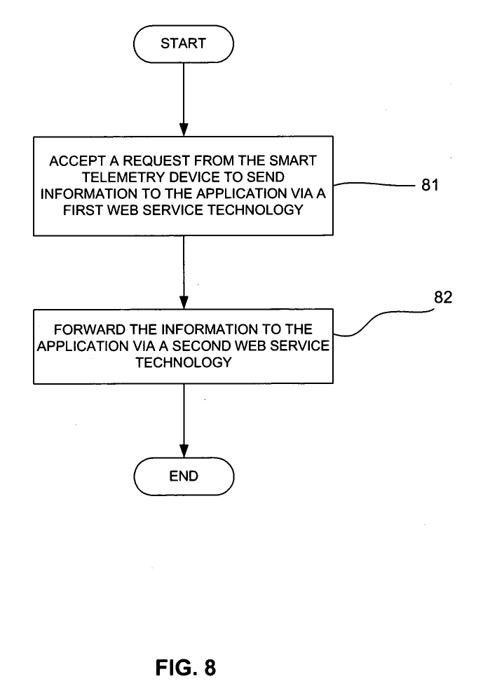

FIG. 8 is a flowchart showing an exemplary method used by a server to proxy communications between a software application and a smart telemetry device where the request is initiated by the smart telemetry device and the communication to and from the smart telemetry device is via a Web Service technology in accordance with an embodiment of the present invention.

In step 81, the server accepts a request from the smart telemetry device to send information to the application via a first Web Service technology.

In step 82, the server then forwards the request to the application via a second Web Service technology.

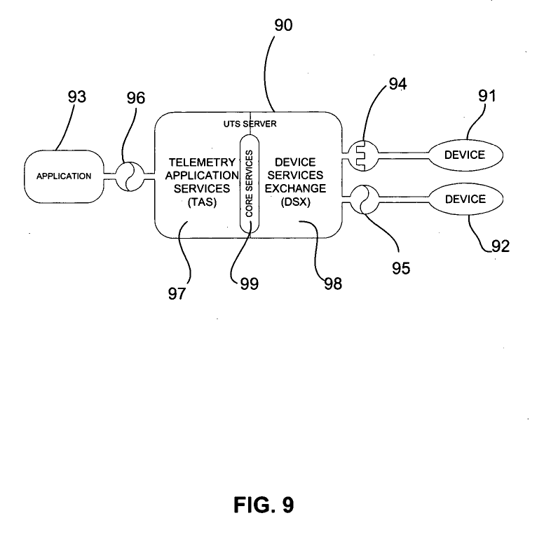

FIG. 9 is a schematic diagram showing the three separate categories of server functions provided by a server that proxies communication between a smart telemetry device and an application in accordance with an embodiment of the present invention. UTS server 90 provides a central point where smart telemetry devices 91, 92 and software application 93 come together. Smart telemetry device 91 is “tightly coupled” to UTS server 90 at 94. This means that smart telemetry device 91 communicates with UTS server 90 using a protocol native to smart telemetry device 91. Smart telemetry device 92 is “loosely coupled” to UTS server 90 at 95. This means that smart telemetry device 92 communicates with UTS server 90 using a Web Service technology including but not limited to XML, SOAP, WSDL, UDDI, HTTP, and SMTP. Similarly, software application 93 is loosely coupled to UTS server 90 at 96.

The first category of functions that UTS server 90 provides is Telemetry Application Services (TAS) 97. TAS 97 allow software applications to manage and access telemetry data. The second category of functions is Devices Services Exchange (DSX) 98. This component allows UTS server 90 to provide telemetry devices with centralized services as well as connectivity to applications. Finally the third category of functions is core services 99. Core services 99 are at the heart of the UTS server 90. Core services 98 provide functionality for both TAS 97 and DSX 98.

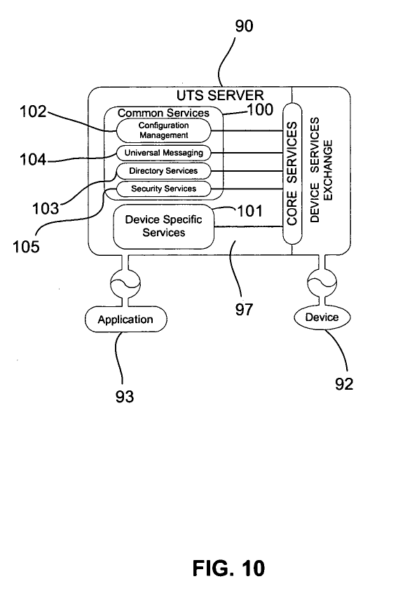

FIG. 10 is a schematic diagram showing the server functions that allow software applications to manage and access telemetry data in accordance with an embodiment of the present invention. Software application 93 communicates with UTS server 90 via TAS 97. TAS 97 are Web Services that provide communication and management interfaces for telemetry devices.

TAS 97 has two main service categories, common services 100 and device specific services 101. Common services 100 provide interfaces that are consistent for all types of telemetry devices. While, device specific services 101 include interfaces that are unique to each class of device.

Through configuration management 102, TAS 97 provide applications with the ability to manage the configuration of devices. Applications can determine the current settings for a device as well as change a specific setting on a group of devices or on a single device. In addition, multiple configuration “personalities” may be stored on the server for each device. Using TAS 97, applications are able to change common settings on any telemetry device without the need of any device specific software library or component.

Directory services 103 provided by TAS 97 enable applications to locate devices using a variety of criteria. Applications are able to quickly and easily locate devices based on serial number, model number, location, state, communication protocol or function of the device. These devices may be located anywhere on the WAN that is managed by UTS server 90.

Applications have the ability to manage device generated messaging using the messaging services 104. Messaging services allow an application to manage where and when messages are sent to users. Devices can send simple messages and alerts to the UTS server 90. UTS server 90 then assumes the responsibility for forwarding the messages and alerts to the appropriate users and applications. Applications can create the rules needed to route messages to users

Protecting and restricting access to telemetry data are the primary functions of security services 105. The UTS server 90 allows administrative applications to manage any access control and security settings for devices. For example, applications may be able to assign owners to devices and group devices into domains.

TAS 97 provide an infrastructure that allows telemetry devices to expose Web Service interfaces that are specific to the device. These device specific services 101 are dynamically created based on the Device Description Document (DDD) for the telemetry device. Applications 93 can use these device specific services to access functions that are unique to the device.

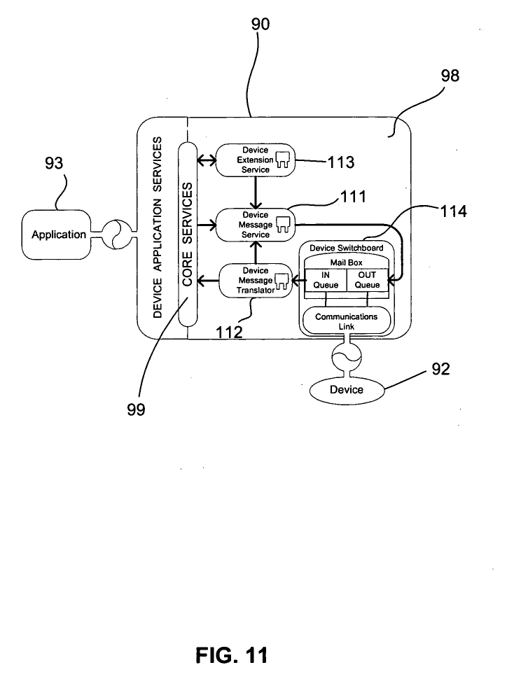

FIG. 11 is a schematic diagram showing the server functions that make up the infrastructure allowing for the smart telemetry device to exchange services with the server in accordance with an embodiment of the present invention. DSX 98 provides an infrastructure for allowing devices to exchange services with a central server. This exchange of services goes in both directions. The central server, UTS server 90, can provide services to smart telemetry device 92 and smart telemetry device 92 can provide services to UTS server 90. DSX 98 enables applications to access the services provided by devices. Also, DSX 98 provides a mechanism that allows services to be offloaded from devices and executed within UTS server 90.

A DDD provides the information required by DSX 98 to support a new class of devices. Portions of the DDD are used by components of DSX 98 to perform device specific functions.

Device Message Service (DMS) 111 provides a mechanism for generating out-bound messages that are specific to the type of device. Messages are generated by calling the DMS API. DMS 111 will then, in turn, execute device specific scripts that create messages specific for the device.

Device Message Translator (DMT) 112 translates incoming device messages into server scripts. The resulting server scripts then call core services 99 as well as DMS 111.

Device Extension Service (DES) 113 allows devices to offload functionality so that it may be executed on UTS server 90. This can reduce the cost of the device while providing increased functionality.

Device Switchboard (DSB) 114 maintains a collection of device mail boxes. Each mail box contains both in and out queues to buffer messages. The mail box then communicates with the device via a communications link. DSB 114 is responsible for routing messages to and from each of the device mail boxes.

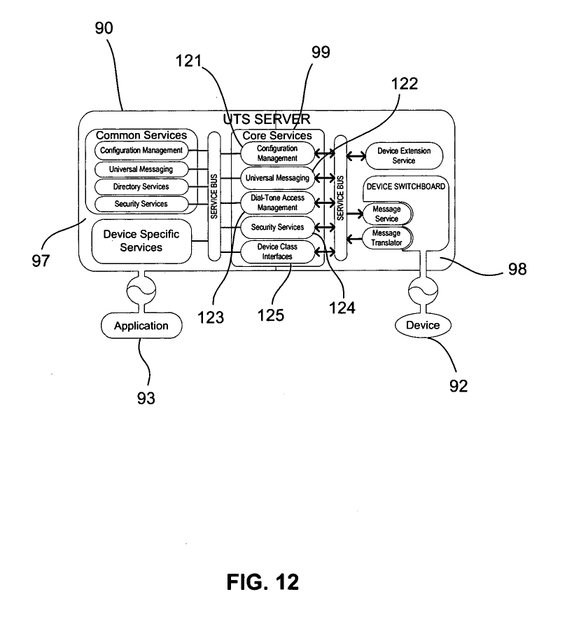

FIG. 12 is a schematic diagram showing the server functions that make up core Web Services that provide functionality to both the software application and the smart telemetry device in accordance with an embodiment of the present invention. Core services 99 are the heart of UTS server 90. Core services 99 provide functionality that is used by both TAS 97 and DSX 98.

Configuration Management Core Service (CMCS) 121 allows devices to use UTS server 90 to store their configuration parameters. Parameters are stored and retrieved using an XML document format. This allows each device to define its own parameters to be stored. CMCS 121 also provides the interface that allows applications to access device configuration parameters via TAS 97.

Universal Messaging Core Service (UMCS) 122 allows devices to generate informative messages. and alerts that can be forwarded to users and applications via email, text messaging, etc. Devices send simple messages to UMCS 122. UMCS 122 then forwards these messages to users and applications based on the rules defined via TAS 97. The device does not need to be aware of any of the details of which users and applications are to receive messages.

Dial-Tone Access Management (DTAM) 123 is a core service that provides the infrastructure that allows devices to communicate using intermittent (or shared) connections as well as communicating behind a Network Address Translated (NAT) firewall. For example, some devices may share a common dial-up Internet connection. These devices need to be programmed with ISP account information and the schedule in which they can make their connections.

Security Core Service (SCS) 124 provides a system that allows devices to communicate with UTS server 90 in a secure and non-repudiated manner. In addition, SCS 124 provides the means of authenticating applications and restricts each application's access to the devices. SCS 124 maintains an access control list for each device. The access control list for a device determines which applications or users are allowed to access it or its data. SCS 124 provides this infrastructure of restricting access as well as the interface that allows applications to administrate each device's access.

Device Class Interfaces (DCI) 125 are core services that allow devices to specify their own interface that can be used by applications. Each device is a member of a particular device class. Each device class may implement its own interface that is described and defined at run-time by the device class information provided by each device. Applications can use DCI 125 to access special device specific functions that are unique to a particular class of devices.

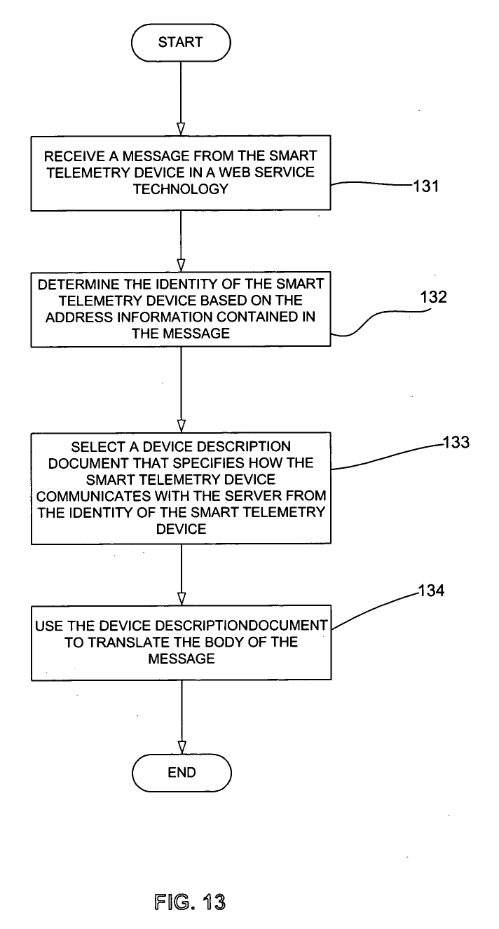

FIG. 13 is a flowchart showing an exemplary method used by a server to translate messages from a smart telemetry device in accordance with an embodiment of the present invention. A DDD is used to describe how a UTS server interfaces to specific class of device. The DDD contains all the information needed to communicate with a given device as well as any specific class information (from the DCI) that is exposed to applications.

In step 131, device XML messages are received by the UTS server. These messages are routed based on address or device class information contained in the XML envelope.

In step 132, the identity of the device that sent the message is determined.

In step 133, the DDD for that device is selected.

In step 134, the message is then translated based on the specification found in the DDD. The resulting translation should produce a server script. This script is then executed to process the payload of the message.

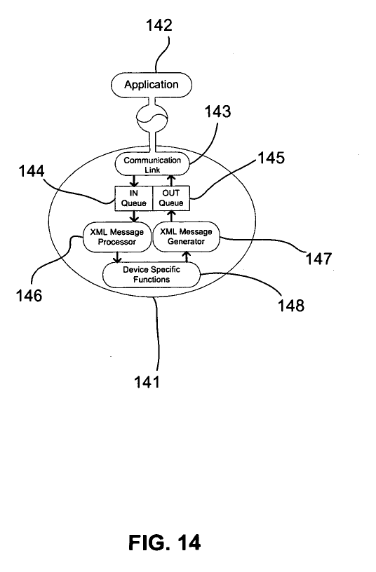

FIG. 14 is a schematic diagram showing an exemplary system allowing a smart telemetry device to communicate with a software application via an XML format in accordance with an embodiment of the present invention. The goal of a Universal Telemetry Access Protocol (UTAP) is to provide a flexible way for a smart telemetry device 141 to communicate with software application 142, while not imposing high levels of complexity and costs on smart telemetry device 141.

Communication link 143 for smart telemetry device 141 is responsible for implementing the UTAP transport layer. At a minimum, communication link 143 must be composed of an IP stack with either TCP or UDP support. However, most devices will want to utilize a common transport that is firewall friendly such as HTTP or SMTP.

To insure messages are not lost due to communication failures or smart telemetry device 141 being busy, both an input message queue, 144, and an output message queue, 145, are required. UTAP only requires that each smart telemetry device must be capable of holding a single message in each queue. The actual implementation of the queue is left to the device designer. Generally, all devices need a memory-based solution for the input queue. However, in some devices it may be desirable to use less memory and simply be capable of re-generating the last message on the output queue. The device itself will define the maximum message size that can be received. However, all UTAP devices are capable of receiving the minimum UTAP message size.

XML message processor 146 is responsible for processing the messages received from an application. The implementation of XML message processor 146 is based on a specialized XML parser. This specialized XML parser is compact in both memory and code requirements. The parser processes the XML envelope of each received message and forwards the payload of the message to the appropriate firmware function.

XML message generator 147 is responsible for packaging message that are to be sent to the application. Other firmware functions call the XML message generator 147 anytime a message needs to be transmitted. When a message is to be generated, an appropriate XML envelope is prepared and the payload of the message is encoded and inserted inside. The message is then sent to software application 142 via output message queue 145.

Device Specific Functions 148 are what makes each type of device different. These functions are the core of the firmware that gives smart telemetry device 141 its functionality. UTAP makes no restrictions on this portion of the firmware.

A DDD is used to describe how an application interfaces to a specific class of device using UTAP. The DDD contains all the information needed to communicate with a given device. Software application 142 references the DDD in order to perform the necessary message translations to and from smart telemetry device 141.

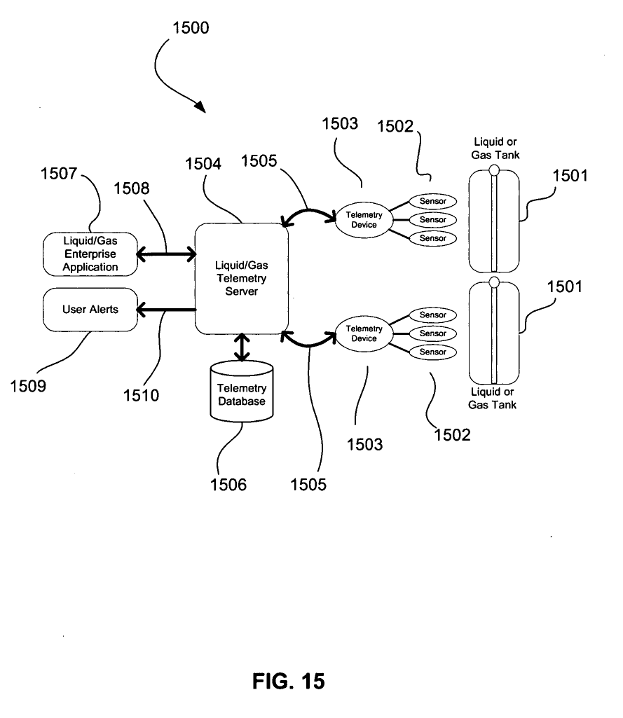

FIG. 15 is a schematic diagram showing an exemplary liquid and gas tank telemetry system in accordance with an embodiment of the present invention. System 1500 includes a monitor device 1502, a controller device 1503, liquid/gas telemetry server 1504, telemetry database 1506, liquid/gas enterprise application 1507, and device for communicating telemetry alerts to a user 1509. Tank 1501 contains a liquid, a gas or a combination of a liquid and a gas. At least one monitor device 1502 is attached to tank 1501 to measure the inventory in the tank and to provide diagnostic information about the tank. One skilled in the art will appreciate that monitor device includes a sensor. This inventory and diagnostic information includes but is not limited to line pressure, tank pressure, tank level, tank temperature, tank leakage detection, and flow rate in and out of the tank. Controller device 1503 automatically receives or reads data from one or more monitor devices, 1502. One skilled in the art will appreciate that controller device 1503 includes a telemetry device and the combination of controller device 1503 and monitor device 1502 includes a smart telemetry device. Monitor device 1502 may be directly connected to controller device 1503 using a serial connection (RS232, RS485, USB, IEEE 1394, modem, etc.). It may be connected using a network connection (Ethernet or PPP). It may also be connected using a wireless connection (802.11, Bluetooth, 802.15, IRDA, or other proprietary wireless protocols).

Controller device 1503 communicates with a liquid/gas telemetry server 1504 via a network (Internet, Ethernet, 802.11, etc.) at 1505. Liquid/gas telemetry server 1504 is responsible for receiving data from controller devices, storing and processing the telemetry data, and providing the raw or processed telemetry data to enterprise application. In addition, the telemetry server may provide alerts to users based on the analysis of the telemetry data. Telemetry database 1506 is used to store and organize the raw and processed telemetry data. Raw data refers to data that has been directly taken from controller device 1503 and has not been interpreted, manipulated or transformed. Processed data refers to data that has been translated, interpreted, manipulated, transformed or reduced. Telemetry database 1506 includes an SQL rational database.

Software application 1507 is any application used by a Liquid/Gas distribution, manufacturing or processing business. An exemplary application includes inventory systems, scheduling and routing, billing/invoice systems and enterprise resource planning systems. Software application 1507 couples to liquid/gas telemetry server 1504 at 1508, coupling 1508 can be, for example, an XML-based interface. This interface may use any network transport layer that is capable of supporting XML payloads. Exemplary transports include HTTP, SMTP, DIME, and SIP.

Users may receive alerts from liquid/gas telemetry server 1504 via device for communicating telemetry alerts to a user 1509 at 1510. Device for communicating telemetry alerts to a user 1509 includes but is not limited to a computer, cellular phone, telephone, PDA, and pager. These alerts inform users of real-time inventory and diagnostic information. The alerts may be delivered as email, pager/text messaging, voice messages or instant messaging. The transport for sending user alerts may be any network transport such as HTTP, SMTP, DIME, or SIP. In addition, other XML based protocols such as SOAP and XML may be utilized in conjunction with the transport layer.

As used to describe embodiments of the present invention, the term “coupled” encompasses a direct connection, an indirect connection, or a combination thereof. Two devices that are coupled can engage in direct communications, in indirect communications, or a combination thereof. Moreover, two devices that are coupled need not be in continuous communication, but can be in communication typically, periodically, intermittently, sporadically, occasionally, and so on. Further, the term “communication” is not limited to direct communication, but also includes indirect communication.

Embodiments of the present invention relate to data communications via one or more networks. The data communications can be carried by one or more communications channels of the one or more networks. A network can include wired communication links (e.g., coaxial cable, copper wires, optical fibers, a combination thereof, and so on), wireless communication links (e.g., satellite communication links, terrestrial wireless communication links, satellite-to-terrestrial communication links, a combination thereof, and so on), or a combination thereof. A communications link can include one or more communications channels, where a communications channel carries communications. For example, a communications link can include multiplexed communications channels, such as time division multiplexing (“TDM”) channels, frequency division multiplexing (“FDM”) channels, code division multiplexing (“CDM”) channels, wave division multiplexing (“WDM”) channels, a combination thereof, and so on.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Systems and methods in accordance with an embodiment of the present invention disclosed herein can advantageously improve the integration of smart telemetry devices with enterprise software applications. The use of a universal telemetry system server accessed via Web Service technology provides applications with a common interface for discovering and configuring devices. The use of a universal telemetry system server accessed via Web Service technology enables smart telemetry devices to define new Web Services dynamically. A liquid and gas telemetry system using these systems and methods provides a real-time view of the of the status of liquid and gas tanks in use. The use of Web Services to develop this system reduces its expense and decreases the complexity of connecting remote device information to enterprise applications.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for communicating with smart telemetry devices as Web Services, the system comprising:
a software application;
a smart telemetry device; and
a server, wherein the server accepts a request from the software application comprising one or more of discovering, configuring, and controlling the smart telemetry device via a Web Service technology, forwards the request to the smart telemetry device via a protocol native to the smart telemetry device, receives information from the smart telemetry device in response to the request via the protocol native to the smart telemetry device, and returns the information to the software application via the Web Service technology.

2. The system of claim 1, wherein the Web Service technology comprises one or more of XML, SOAP, WSDL, UDDI, HTTP, and SMTP.

3. The system of claim 1, wherein the smart telemetry device comprises one or more of a controller device and a monitor device.

4. A method used by a server to proxy the communication between a software application and a smart telemetry device, the method comprising:
accepting a request from the software application comprising discovering, configuring, and controlling the smart telemetry device via a Web Service technology;
forwarding the request to the smart telemetry device via a protocol native to the smart telemetry device;
receiving information from the smart telemetry device in response to the request via the protocol native to the smart telemetry device; and
returning the information to the software application via the Web Service technology.

5. The method of claim 4, wherein the Web Service technology comprises one or more of XML, SOAP, WSDL, UDDI, HTTP, and SMTP.

6. The system of claim 4, wherein the smart telemetry device comprises one or more of a controller device and a monitor device.

7. A system for communicating with smart telemetry devices as Web Services, the system comprising:
a software application;
a smart telemetry device; and
a server, wherein the server accepts a request from the software application comprising discovering, configuring, and controlling the smart telemetry device via a first Web Service technology, forwards the request to the smart telemetry device via a second Web Service technology, receives information from the smart telemetry device in response to the request via the second Web Service technology, and returns the information to the software application via the first Web Service technology.

8. The system of claim 7, wherein the first Web Service technology comprises one or more of XML, SOAP, WSDL, UDDI, HTTP, and SMTP.

9. The system of claim 7, wherein the second Web Service technology comprises one or more of XML, SOAP, WSDL, UDDI, HTTP, and SMTP.

10. The system of claim 7, wherein the smart telemetry device comprises one or more of a controller device and a monitor device.

11. The system of claim 7, wherein the server provides Web Services accessible to the software application that provide communication and management interfaces for the smart telemetry device, an infrastructure allowing for the smart telemetry device to exchange services with the server, and core Web Services that provide functionality to both the software application and the smart telemetry device.

12. The system of claim 11, wherein the Web Services accessible to the software application that provide communication and management interfaces for the smart telemetry device comprise configuration management that allows the application to determine the current settings for the smart telemetry device and to change a specific setting on the smart telemetry device.

13. The system of claim 11, wherein the Web Services accessible to the software application that provide communication and management interfaces for the smart telemetry device comprise a directory service that enables the application to locate the smart telemetry device based on one or more of serial number, model number, location, state, communication protocol, and function of the smart telemetry device.

14. The system of claim 11, wherein the Web Services accessible to the software application that provide communication and management interfaces for the smart telemetry device comprise a messaging service that allows the application to manage the messages and alerts that the smart telemetry device can send.

15. The system of claim 11, wherein the Web Services accessible to the software application that provide communication and management interfaces for the smart telemetry device comprise a security service that allows the application to manage the access control and security settings for the smart telemetry device.

16. The system of claim 11, wherein the Web Services accessible to the software application that provide communication and management interfaces for the smart telemetry device comprise a device specific service that allows the application to access functions that are specific to the smart telemetry device.

17. The system of claim 11, wherein the infrastructure allowing for the smart telemetry device to exchange services with the server comprises a device message service that provides a mechanism for generating out-bound messages that are specific to the smart telemetry device.

18. The system of claim 11, wherein the infrastructure allowing for the smart telemetry device to exchange services with the server comprises a device message translator that translates incoming messages from the smart telemetry device into server scripts.

19. The system of claim 11, wherein the infrastructure allowing for the smart telemetry device to exchange services with the server comprises a device extension service that allows the smart telemetry device to offload functionality so that it may be executed on the server.

20. The system of claim 11, wherein the infrastructure allowing for the smart telemetry device to exchange services with the server comprises a device switchboard that is responsible for routing in and out message queues of the smart telemetry device.

21. The system of claim 11, wherein the core Web Services that provide functionality to both the software application and the smart telemetry device comprise a core configuration management service that allows the smart telemetry device to store its configuration parameters on the server.

22. The system of claim 11, wherein the core Web Services that provide functionality to both the software application and the smart telemetry device comprise a universal message service that allows the smart telemetry device to store its message on the server.

23. The system of claim 11, wherein the core Web Services that provide functionality to both the software application and the smart telemetry device comprise a dial-tone access management service that allows the smart telemetry device to communicate with the application using intermittent or shared connections.

24. The system of claim 11, wherein the core Web Services that provide functionality to both the software application and the smart telemetry device comprise a security core service that allows the smart telemetry device to communicate in a secure and non-repudiated manner.

25. The system of claim 11, wherein the core Web Services that provide functionality to both the software application and the smart telemetry device comprise a device class interface service that allows the smart telemetry device to specify the interface that that the application can use to access the smart telemetry device.

26. A method used by a server to proxy communication between a software application and a smart telemetry device, the method comprising:
accepting a request from the software application comprising discovering, configuring, and controlling the smart telemetry device via a first Web Service technology;
forwarding the request to the smart telemetry device via a second Web Service technology;
receiving information from the smart telemetry device in response to the request via the second Web Service technology; and
returning the information to the software application via the first Web Service technology.

27. The method of claim 26, wherein the first Web Service technology comprises one or more of XML, SOAP, WSDL, UDDI, HTTP, and SMTP.

28. The method of claim 26, wherein the second Web Service technology comprises one or more of XML, SOAP, WSDL, UDDI, HTTP, and SMTP.

29. The system of claim 26, wherein the smart telemetry device comprises one or more of a controller device and a monitor device.

30. A method used by a server, which acts as a proxy between a smart telemetry device and an application, to communicate with the smart telemetry device, the method comprising:
receiving an message from the smart telemetry device in a Web Service technology;
determining the identity of the smart telemetry device based on one or more of address and device class information contained in the message;
selecting a device description document that specifies how the smart telemetry device communicates with the server from the identity of the smart telemetry device; and
using the device description document to translate the body of the message.

31. The method of claim 30, wherein the Web Service technology comprises XML.

32. A system for a smart telemetry device to communicate with an application via an XML format, the system comprising:
a communications link that provides the transport for exchanging messages between the smart telemetry device and the application;
an input message queue that stores incoming messages;
an output message queue that stores outgoing messages;
an XML message processor that parses the incoming message and forwards the payload of the incoming message to a firmware function;
an XML message generator that converts a firmware-generated message to XML; and
device specific functions that are firmware functions that make up the smart telemetry device's functionality.

33. A liquid and gas tank telemetry system, the system comprising:
a tank containing material comprising one or more of a liquid and a gas;
a monitor device that is attached to the tank to provide information about the tank;
a controller device that automatically receives or reads data from the monitor device;
a telemetry database that stores telemetry data;
a software application;
a device for communicating telemetry alerts to a user; and
a telemetry server that communicates with the controller device, retrieves and stores data in the telemetry database, provides an interface to the software application, and forwards telemetry alerts to a means for communication telemetry alerts to a user.

34. The system of claim 33, wherein the monitor device that is attached to the tank to provide information about the tank comprises one or more sensors that measure one or more of tank pressure, line pressure, tank level, tank temperature, tank leakage detection, and flow rate in and out of the tank.

35. The system of claim 33, wherein the software application comprises one or more of inventory, scheduling and routing, billing or invoice, and enterprise resource planning systems.

36. The system of claim 33, wherein the device for communication telemetry alerts to a user comprises one or more of a computer receiving email, a PDA receiving email, a cellular phone receiving email, a PDA receiving text messaging, a cellular phone receiving text messaging, a pager receiving text messaging, a cellular phone receiving voice messaging, a telephone receiving voice messaging, a PDA receiving instant messaging, a cellular phone receiving instant messaging, and a computer receiving instant messaging.

37. A method used by a server to facilitate the communication between a software application and a smart telemetry device, the method comprising:
accepting a request from the smart telemetry device to send information to the application via a protocol native to the smart telemetry device; and
forwarding the information to the application via a Web Service technology.

38. The method of claim 37, wherein the Web Service technology comprises one or more of XML, SOAP, WSDL, UDDI, HTTP, and SMTP.

39. The system of claim 37, wherein the smart telemetry device comprises one or more of a controller device and a monitor device.

40. A method used by a server to facilitate the communication between a software application and a smart telemetry device, the method comprising:
accepting a request from the smart telemetry device to send information to the application via a first Web Service technology; and
forwarding the information to the application via a second Web Service technology.

41. The method of claim 40, wherein the first Web Service technology comprises one or more of XML, SOAP, WSDL, UDDI, HTTP, and SMTP.

42. The method of claim 40, wherein the second Web Service technology comprises one or more of XML, SOAP, WSDL, UDDI, HTTP, and SMTP.

43. The system of claim 40, wherein the smart telemetry device comprises one or more of a controller device and a monitor device.
